(19) United States
(12) Patent Application Publication
(10) Pub. No.: US 2012/0032087 A1
(43) Pub. Date: Feb. 9, 2012

(54) LIGHT COLLECTING OPTICAL FIBER, PHOTODETECTION SYSTEM, OPTICAL COUPLING STRUCTURE AND RADIO RAY DETECTION SYSTEM

(75) Inventor: Hiroshi Sugihara, Tokyo (JP)

(73) Assignee: WIRED JAPAN CO., LTD., Tokyo (JP)

(21) Appl. No.: 12/851,139

(22) Filed: Aug. 5, 2010

(51) Int. Cl. G01T 1/203; G01T 1/204; G01J 1/04; G01T 1/20; G02B 6/02; G02B 6/00

(52) U.S. Cl. 250/367; 385/123; 362/551; 250/227.11; 250/206.1; 250/368

(57) ABSTRACT

A light collecting optical fiber improves light injection efficiency into the optical fiber. The light collecting optical fiber is equipped with a plurality of optical waveguide portions and light collecting portions between the adjacent optical waveguides. The optical waveguide portion includes a core and a cladding layer surrounding the core and constitutes an optical fiber. The light collecting portion is formed in a shape bulging out in radial direction from the optical waveguide portion and is constituted so that it injects external light to the optical waveguide portion.

### FIELD OF THE INVENTION

The present invention relates to the light collecting optical fibers and the photodetection systems using the fibers, optical coupling structures and radioactive ray detecting units, particularly to photodetection technology by using the optical fibers.

### BACKGROUND ART

A photodetection system is one of the important applications of the optical fiber. When a physical phenomenon generates a light, the generated light can be injected to a photodetector (for example, a photomultiplier,) and thus the physical phenomenon can be detected by detecting the light by the photodetector. The use of the optical fiber increases the degree of freedom in configuration of locations where the light is actually generated and where the detector is placed, thus makes it easier to configure the optical detection system. For example, by using the optical fiber, a photodetection system can be realized in which the place where the light being generated and the place where the light being detected are remote to each other.

In the photodetection system using the optical fibers, one of the requirements is to improve the injection efficiency of light into the optical fiber. The injection of the light into the optical fiber is generally made by inputting the light to the end surface of the optical fiber. And, improvement of the injection efficiency is made by adjusting the structure of the end portion where the end surface locates. For example, Japanese patent publication gazette S63-98610 discloses a technology to improve the efficiency of sending and receiving of optical signal by increasing the outer size of the end portion of the optical fiber. On the other hand, the Japanese patent publication gazette S63-303309 discloses an approach to improve the injection efficiency of light into the optical fiber by forming a reverse direction corn at the end portion and a lens at the end surface.

However, based on the study by the inventor, there is a limit in the approach injecting the light into the optical fiber from the end of the optical fiber. The approach of inputting light from the end surface of the optical fiber is not a preferable choice, particularly when the size of the light source is large, because the spatial area available is limited.
[Patent reference 1] Japanese patent publication gazette S63-98610
[Patent reference 2] Japanese patent publication gazette S63-303309

### DISCLOSURE OF THE INVENTION

Therefore, an objective of the present invention is to improve the injection efficiency of light into an optical fiber, particularly when the physical size of the light source is large.

### SUMMARY OF THE INVENTION

According to one of the aspects of the present invention, a light collecting optical fiber comprises a plurality of optical waveguide portions and a light collecting portions inserted between two adjacent optical waveguide portions. Each of the plurality of optical waveguide portions comprises a core and a cladding layer surrounding the core. The light collecting portion is formed in a shape bulging out in radial direction, in order to collect an external light into the optical waveguide portion. The light collecting optical fiber constituted as above can collect light from intermediate portions of an optical fiber, and thus effectively increases the collection efficiency of light. For example, when the physical size of the light source is large, the light collecting optical fiber with high collection efficiency can be constituted by aligning desirable number of light collecting portions corresponding the spatial alignment of the light source and thus receiving light from the wide range of the light source.

The light collecting optical fiber may be formed so that light is also received from an end of a sensing portion of the optical fiber. For example, an end collecting portion having a shape bulging out in radial direction may be formed at the end of the sensing portion of the light collecting optical fiber. In another example, the light collecting optical fiber may be formed so that it reflects light at the end. The light collecting optical fiber may be formed so that light can be taken out from both ends of the optical fiber.

When the light collecting optical fiber is formed so that it reflects light at the end, a photodetection system detecting an incident location of the external light incident to the light collecting optical fiber can be configured. More specifically, the photodetection system is configured comprising, the light collecting optical fiber which is configured to reflect light at the end, a photodetector connected at a base end of the light collecting optical fiber, and a signal processor, receiving the output signal of the photodetector. From the output signal, the signal processor calculates, a first time when a first light component of a collected light collected from the external light by the light collecting optical fiber, arrives at the photodetector without being reflected at the end of the light collecting fiber, and a second time when a second light component of the collected light, arrives at the photodetector after being reflected at the end of the light collecting optical fiber. The signal processor calculates the incident location of the external light incident to the light collecting optical fiber from the first time and the second time.

The photodetection system detecting the incident location of the external light incident to the light collecting optical fiber can also be configured, when the light collecting optical fiber is configured so that the light can be taken out from both ends of the optical fiber. In one of the embodiments, the photodetection system comprises, a light collecting optical fiber which is configured so that the light can be taken out from both ends, a photodetector which is connected to one end of the light collecting optical fiber, a light reflecting means connected to the other end of the light collecting optical fiber, and a signal processor which receives the output signal of the photodetector. From the output signal, the signal processor calculates, the first time when the first light component of a collected light collected from the external light by the light collecting optical fiber, arrives at the photodetector without being reflected at the light reflecting means, and the second time when the second light component of the collected light, arrives at the photodetector after being reflected at the light reflecting means. The signal processor calculates the incident location of the external light incident to the light collecting optical fiber from the first time and the second time.

In another embodiment, a photodetection system is configured comprising, the light collecting optical fiber, a first photodetector connected to the first end of the light collecting optical fiber, a second photodetector connected to the second end of the light collecting optical fiber, and a signal processor receiving output signals from the first and the second photodetectors. The signal processor calculates the location of the light incident to the light collecting optical fiber, from the first time that the first light component arrives at the first photodetector and the second time that the second light component arrives at the second photodetector.

The above described light collecting optical fiber can be applied to an optical coupling structure, which realizes optical coupling with a light source using light guides. In one of the embodiments, when the light source is located on an extended line of the center axis of the light collecting optical fiber, the light guide is attached to the light source and is constituted to include a portion, which is so configured so that the further from the light source the portion is, the smaller the diameter of the portion.

In another embodiment, where a light emitting surface of the light source is aligned parallel to the center axis of the light collecting optical fiber, the light guide is attached to the light emitting surface, and has a body part, the outer surface of which plots a parabola in a cross sectional view perpendicular to the center axis of the light collecting optical fiber, with an axis of the parabola perpendicular to the light emitting surface. The light collecting optical fiber is aligned so that the center axis is at the focal point of the parabola.

In other embodiment, a light guide comprises a body part which is attached to the light emitting surface, and an end portion formed at the end of the body part and is attached to the light emitting surface. The body part has a surface shape which plots a first parabola in a cross section that is perpendicular to the center axis of the light collecting optical fiber, with an axis of the parabola perpendicular to the light emitting surface, where the center axis of the light collecting optical fiber is aligned at the focal point of the first parabola. The end portion has a surface shape which plots a second parabola in a cross section that includes the center axis and is perpendicular to the light emitting surface, with an axis of the parabola perpendicular to the light emitting surface, where the end collective portion of the light collective optical fiber is at the focal point of the second parabola.

A radioactive ray detector unit which detects radioactive ray is one of the embodiments of the light collecting optical fiber described above. A radioactive ray detector can be configured with the light collecting optical fiber and a scintillator, which is placed adjacent to the light collecting optical fiber. In one of the embodiments, a part of the light collecting optical fiber including at least the light collecting portion is inserted into the hole opened at the scintillator. Here, it is preferable to fill an optical gel having a refractive index between the refractive index of the scintillator and that of a core of the optical fiber, in the space between the surface of the hole and the light collecting optical fiber.

When the scintillator is a plastic scintillator, it is preferable that the light collecting optical fiber is embedded in the plastic scintillator so that the whole part of the surface of the light collecting optical fiber, which is inside the plastic scintillator, adheres to the plastic scintillator.

The scintillator may be a liquid scintillator. In this case, the radioactive ray detector unit will have a sealed housing which includes the liquid scintillator and at least the light collecting portions of the light collecting optical fiber.

Using the light collecting optical fiber, it is possible to configure the radioactive ray detector which detects the type of radioactive rays in addition to the fact that the radioactive rays were incident. In this case, a plurality of scintillators will be aligned adjacent to the light collecting optical fiber. The plurality of scintillators have sensitivity to different types of radioactive rays and also generates light with different wavelengths.

It is also possible to constitute a radioactive ray detection unit which detects radioactive ray images, using the light collecting optical fiber. In one of the embodiments, the radioactive ray detector comprises a number of the light collecting optical fibers and a scintillator structure having a number of scintillator blocks separated by slit and a base part which connects the plurality of scintillator blocks. The plurality of light collecting optical fibers are inserted into the holes formed in the scintillator blocks. Here, it is preferable that an optical gel having a refractive index between the refractive index of the scintillator and that of the core of the optical fiber, is filled into the space between the surface of the hole and the light collecting optical fiber.

By the present invention, the injection efficiency of light into the optical fiber can be improved.

### BRIEF DESCRIPTION OF THE DRAWINGS

FIG. 1 is a cross sectional illustration of the structure of the light collecting optical fiber in one of the embodiments of the present invention.

FIG. 2 is an enlarged cross sectional illustration of the structure of the light collecting portion in the light collecting optical fiber of FIG. 1.

FIG. 3 is a table showing the results of experiments on external light collection by the light collecting optical fiber of the present invention.

FIG. 4A is a cross sectional illustration of the structure of the light collecting optical fiber in another embodiment of the present invention.

FIG. 4B is an enlarged cross sectional illustration of the structure of the end portion of the light collecting optical fiber of FIG. 4A.

FIG. 4C is a cross sectional illustration of the structure of the light collecting optical fiber of the present invention in further another embodiment.

FIG. 4D is an enlarged cross sectional illustration of the structure of the end portion of the light collecting optical fiber of FIG. 4C.

FIG. 5 is a cross sectional illustration of the structure of the light collecting optical fiber of the present invention, in further another embodiment.

FIG. 6 is a conceptual structure of the photodetection system under one embodiment of the present invention.

FIG. 7 is a conceptual structure of the photodetection system under another embodiment of the present invention.

FIG. 8 is a conceptual structure of the photodetectionsystem under further another embodiment of the present invention.

FIG. 9 is a conceptual structure of the photodetectionsystem under further another embodiment of the present invention.

FIG. 10 is a cross sectional illustration of the optical coupling structure under one embodiment of the present invention.

FIG. 11A is a cross sectional illustration of the optical coupling structure under another embodiment of the present invention.

FIG. 11B is a cross sectional illustration of the optical coupling structure under another embodiment of the present invention.

FIG. 12A is a cross sectional illustration of the structure of the radioactive ray detector unit under one embodiment of the present invention.

FIG. 12B is a cross sectional illustration of the structure of the radioactive ray detector unit under another embodiment of the present invention.

FIG. 12C is a cross sectional illustration of the structure of the radioactive ray detector unit under further another embodiment of the present invention.

FIG. 13A is a cross sectional illustration of the structure of the radioactive ray detector unit under further another embodiment of the present invention.

FIG. 13B is a cross sectional illustration of the structure of the radioactive ray detector unit under further another embodiment of the present invention.

FIG. 13C is a cross sectional illustration of the structure of the radioactive ray detector unit under further another embodiment of the present invention.

FIG. 14 is a bird's eye view of the structure of the radioactive ray detector unit under further another embodiment of the present invention.

FIG. 15 is a bird's eye view of the structure of the radioactive ray detector unit under further another embodiment of the present invention.

FIG. 16 is an illustration of a fabrication method of the scintillator body for the radioactive ray detector unit of FIG. 15.

FIG. 17 is an enlarged cross sectional view of the radioactive ray detector of FIG. 15.

### EXPLANATION ON NOTATIONS

10: light collecting optical fiber
10a: center axis
10b: end surface
1: optical waveguide portions
2: light collecting portions
3: end collecting portion
4: external light
5: high reflection coating
6: low refractive index coating
11: core
11a: surface
12: cladding layer
12a: surface
13: cross section
21, 21a, 21b: optical fiber
22, 22a, 22b: photomultiplier
23: signal processor
24: external light
25, 25a, 26, 26a, 26b: optical component
27: optical fiber
28: reflector
31: light source
31a: light emitting surface
32: light guide
32a: body part
33: connecting sleeve
33a: body part
33b: receptacle tube
34: optical fiber
35: light shield tube
36: light guide
36a: body part
41: scintillator
41a: hole
42: optical gel
43: seal
44: plastic scintillator
45: enclosure container
46: liquid scintillator
47: seal
51, 52, 53: scintillator
54, 55, 56: radioactive ray
61: scintillator body
62: scintillator block
63: base
64: rotary teeth
65: optical gel
66: seal
67: optical fiber

### DETAILED DESCRIPTION OF THE INVENTION

1. Configuration of a Light Collecting Optical Fiber

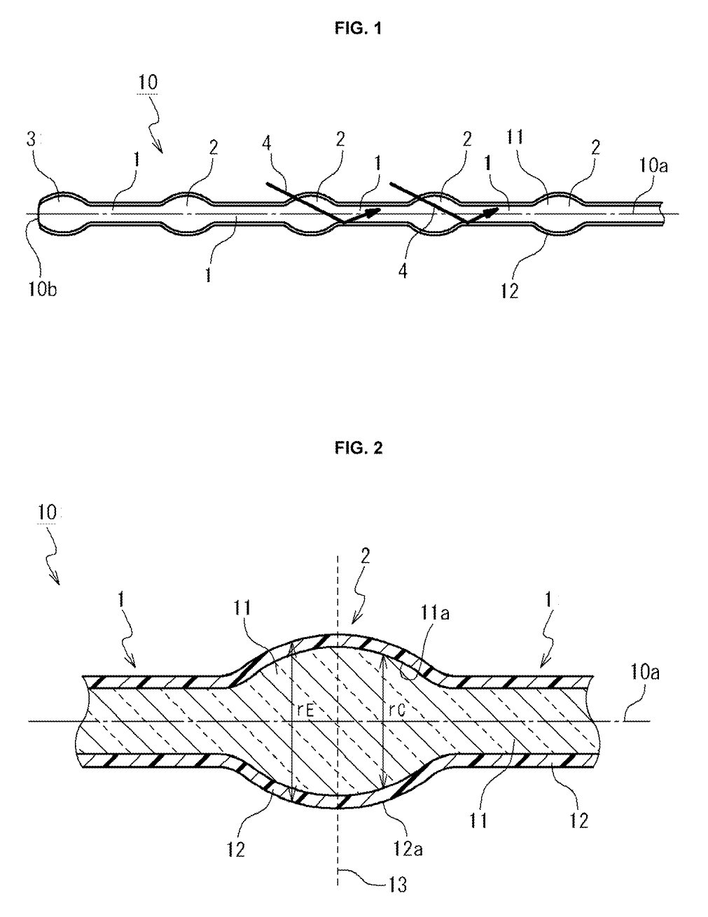

FIG. 1 shows a cross sectional view of the light collecting optical fiber 10 in one of the embodiments of the present invention. The light collecting optical fiber 10 has a plurality of optical waveguide portions 1. The optical waveguide portions 1 comprises core 11 and cladding layer 12 surrounding the core 11 so that it functions as an optical fiber. That is, so that it guides light by total reflection of light. In one of the embodiments, the core 11 is made of quartz, the cladding layer 12 is made of fluorine resin. The optical waveguide portion has a circular cross sectional shape and its outer diameter is constant along the length direction. Each optical waveguide portions 1 is aligned so that its center axis fits in the center axis 10a of the light collecting optical fiber 10.

The light collecting portion 2 is inserted between the two adjacent optical waveguide portions 1. The light collecting portion 2 is formed by causing outward bulge in radial direction from the optical waveguide portions and is configured so that it can inject light from external into the optical waveguide portion 1. In this embodiment, the light collecting portion 2 is formed so that it has a circular outer shape in a cross section perpendicular to the center axis 10a of the light collecting optical fiber 10, where the outer diameter of the light collecting portion 2 is larger than that of the optical waveguide portions 1.

FIG. 2 shows a cross sectional view of the structure of the light collecting portion in one of the embodiments of the present invention. The light collecting portion 2 also comprises of core 11 and cladding layer 12 as the optical waveguide portion 1 does. The light collecting portion 2 is formed in barrel shape, where the diameter r_{c} of the core 11 of which is larger than the diameter of the core 11 of the optical waveguide portion 1. The light collecting portion 2 is configured so that the diameter r_{c} of the core increases gradually towards the cross section 13 (that is, it increases mathematically monotonically), having a maximum value at the cross section 13 which is perpendicular to the center axis 10a of the light collecting optical fiber 10. Accordingly, the outer diameter r_{E} of the light collecting portion 2 also gradually increases toward the cross section 13. At the cross section 13, the rate of change of the diameter r_{c} of the core 11 (also the rate of change of the outer diameter r_{E} of the light collecting portion) is zero. The light collecting portion 2 is also configured so that the shape of the outer surface 11a of the core 11 and the shape of the outer surface 12a of the cladding layer 12 in a cross section including the center axis 10a of the light collecting optical fiber 10 form smooth curves. The structure of the light collecting portion 2 as described here contributes to collect and inject light efficiently to the optical waveguide portion 1.

The light collecting optical fiber 10 shown in FIG. 1 includes the light collecting portion 3 at the end of the optical waveguide portion. The light collecting portion 3 is also formed so that it bulges out in radial direction from the waveguide portion 1 and configured in order to collect and inject external light into the optical waveguide portion 1. The light collecting portion 3 enables injecting external light into the optical waveguide portion not only from the end surface 10b but also from side surface.

The light collecting optical fiber 10 of FIG. 1 can inject external light 4 into optical waveguide portion 1 not only from end surface 10b of the light collecting optical fiber 10 but also from side surface of the light collecting portion 2, 3 and thus can improve injection efficiency. The light collecting optical fiber 10 of such structure is particularly preferable when the size of the light source which generates the external light 4 is large. By designing locations and numbers of the light collecting portions 2, 3 in accordance with the size of the light source, the light collecting optical fiber 10 of FIG. 1 can efficiently collect and inject external light into the optical waveguide portion 1.

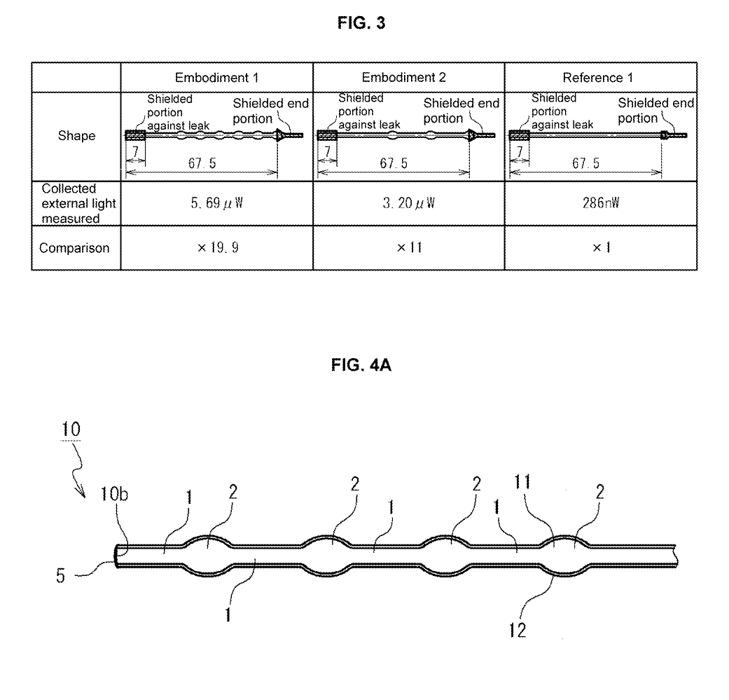

The applicant actually manufactured the light collecting optical fiber 10 experimentally, and measured the performance of collecting the external light. FIG. 3 shows the results of those measurements. Here, the embodiments 1 and 2 represent the light collecting optical fibers fabricated. As for the reference 1, a conventional plastic optical fiber having no light collecting portions was used. In the embodiment 1, five light collecting portions were built in the mid portion of the light collecting optical fiber 10, and further the light collecting portion 3 was also built in the end of the optical fiber. On the other hand, in the embodiment 2, two light collecting portions were built in the middle portion of the light collecting optical fiber 10. In order to prove that the light collection from side surface of the light collecting portion 2 is possible, the end surfaces 10b of the light collecting optical fiber 10 of the embodiments 1 and 2 were shielded from external light. The end surface of the reference 1 was also shielded. Total length of the light collecting optical fiber 10 in the embodiments 1, 2 and the plastic optical fiber of the reference 1 was 67.5 mm. The light source was a U shaped fluorescent lamp of 20 W, the distance of which from the light collecting optical fiber 10 or the plastic optical fiber was about 20 cm. An optical power meter was connected at the base end of the light collecting optical fiber 10 or the plastic optical fiber, and measured light power collected by the light collecting optical fiber 10 or the plastic optical fiber.

As shown in FIG. 3, the reference 1 without the light collecting portion only collected 296 nW power from external light. While the embodiments 1 and 2 collected 5.69 μW and 3.20 μW, respectively. These results demonstrate that the light collecting portion 2 of the light collecting optical fiber 10 indeed has the function to collect the light from the external light.

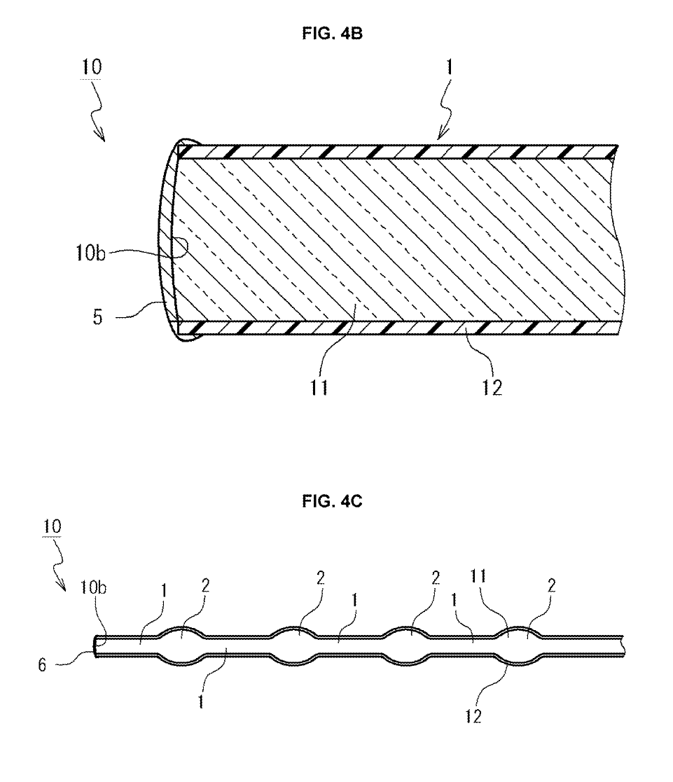

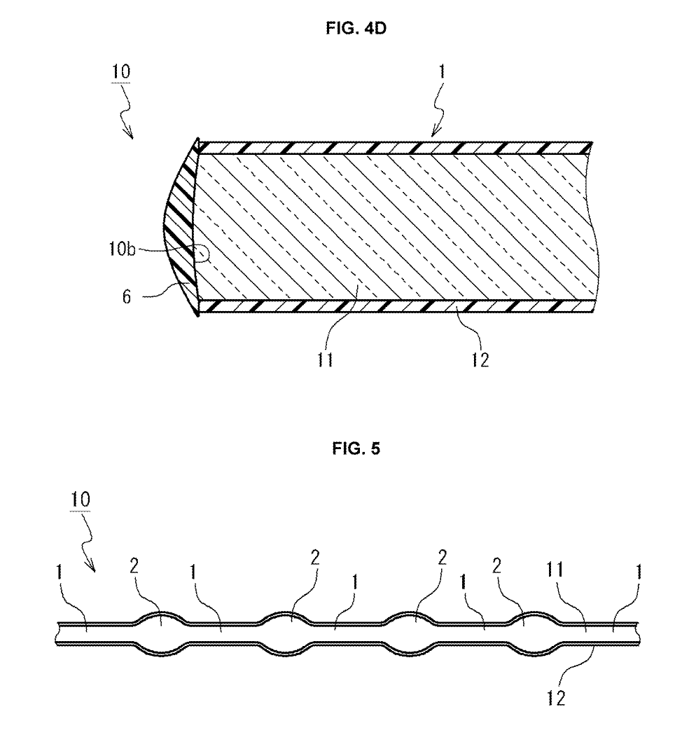

The light collecting optical fiber 10 without the light collecting portion at the end of the optical fiber is one of the feasible options as shown in FIGS. 4A to 4D. In these embodiments, the optical waveguide portion 1 at the end of the light collecting optical fiber 10 may be configured so that it reflects light at the end surface, for example, as shown in FIG. 4A and its enlarged view FIG. 4B. For example, as shown in FIG. 4B, a high reflection coating 5 may be formed at the end surface 10b of the optical waveguide portion 1 at the end of the light collecting optical fiber 10. As for the high reflection coating 5, for example, a metal coating may be used. In such a configuration, the light traveling toward the end of the light collecting optical fiber 10 is reflected towards the direction of the base end of the light collecting optical fiber 10.

As shown in FIG. 4C and in its enlarged view FIG. 4D, the light collecting optical fiber 10 may be configured so that it collects light from the end surface 10b. In this case, the end surface 10b may be coated by a layer of a low refractive index. The layer of a low refractive index is formed of a material having a refractive index higher than that of air but lower than that of the core 11, such as AMORPHOUS TEFLON (registered trademark), for example. The layer of a low refractive index is formed so that it is thicker at the center portion than the peripheral portion, by which the collecting efficiency of light is expected to be improved.

Further as shown in FIG. 5, the light collecting optical fiber 10 may be configured so that light outputs are taken out from both ends of the optical fiber. In this case, by connecting a first photodetector at one end of the light collecting optical fiber 10, and a second photodetector at another end, light output from each end of the light collecting optical fiber 10 can be detected.

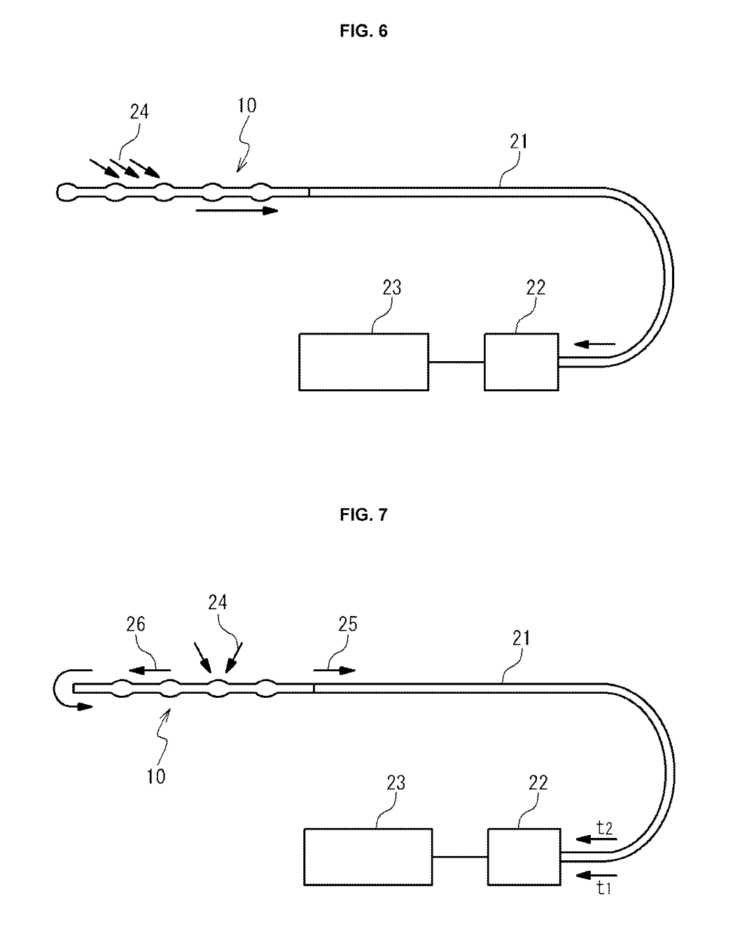

FIGS. 6 to 9 show examples for the photodetection systems using the light collecting optical fibers 10. In the photodetection system shown in FIG. 6, the optical fiber 21 is connected to the base end of the light collecting optical fiber 10 as configured in FIG. 1, and the optical fiber 21 is further connected to the photomultiplier 22. The output of the photomultiplier 22 is transmitted to the signal processor 23. When the light collecting optical fiber 10 is exposed with external light 24, the light collected by the light collecting optical fiber 10 is sent to the photomultiplier 22 via the optical fiber 21. The photomultiplier 22 detects the light input from the optical fiber 21. The signal processor 23 detects the input of the light to the light collecting optical fiber 10 from the output of the photomultiplier 22. By the way, when the light collecting optical fiber 10 (or the optical waveguide 1 located at the end of it) is long enough, the light collecting optical fiber 10 may be directly connected to the photomultiplier 22.

Referring to FIG. 7, it is possible to detect the incident location of external light, by using the light collecting optical fiber 10 configured to reflect light at the end, as shown in FIGS. 4A and 4B. More specifically, when external light 24 was incident to the light collecting optical fiber 10, a light component 25, which is a component of light collected by the light collecting optical fiber 10, and which travels toward base end of the light collecting optical fiber 10, will input to the photomultiplier 22 without being reflected. On the other hand, a light component 26 which travels toward the end of the light collecting optical fiber 10, will input to the photomultiplier after being reflected at the end. The signal processor 23 detects the location of light incident from the output of the photomultiplier 22. More specifically, the signal processor 23 detects a time t₁ when the light component 25 that was not reflected at the end of the light collecting optical fiber 10 arrived at the photomultiplier 22, and a time t₂ when the light component 26 that was reflected at the end of the light collecting optical fiber 10 arrived at the photodetector 22. Here, time difference Δt=t₂−t₁ depends on the distance from the photomultiplier to the incident location. In other words, an incident location close to the end of the light collecting optical fiber 10 causes a small time difference Δt, and a remote incident location causes a large time difference Δt. Therefore, the incident location of external light in the light collecting optical fiber 10 can be detected from the time difference Δt. The signal processor 23 calculates the time difference Δt from the time t₁ and the time t₂, and estimates the location where the light was incident in the light collecting optical fiber 10 from the time difference Δt.

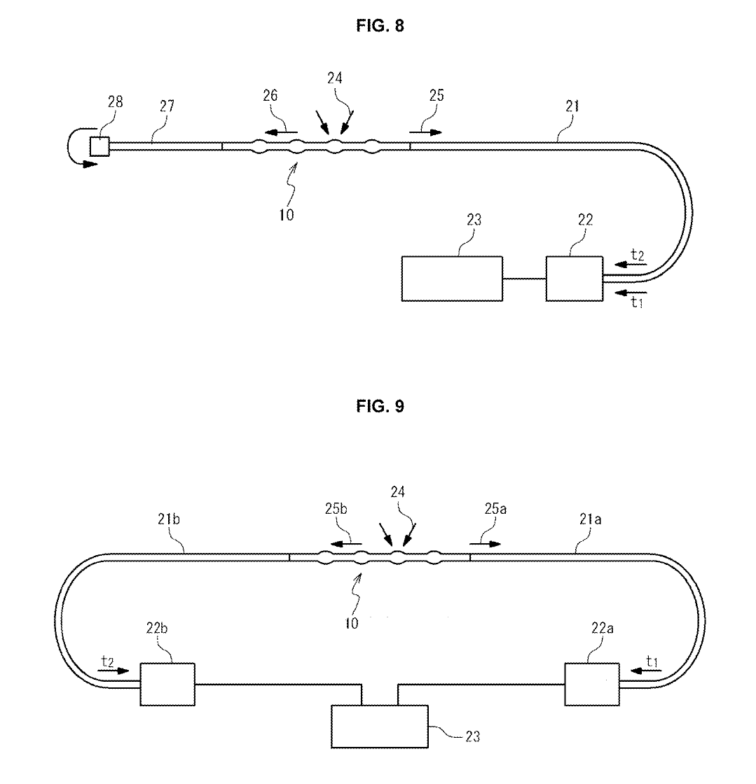

As shown in FIGS. 8 and 9, the incident location of external light can be detected when the light collecting optical fiber 10 which is configured to enable the light detection at both ends is used. In the configuration illustrated in the FIG. 8, one end of the light collecting optical fiber 10 is connected to the photomultiplier 22 via the optical fiber 21, and the other end of the light connecting optical fiber is connected to the one end of the optical fiber 27. The other end of the optical fiber 27 is connected to the reflector 28 which functions as a light reflecting means. A light component 25 of the light collected by the light collecting optical fiber 10, which travels toward one end of the light collecting optical fiber 10, inputs into the photomultiplier 22 via the optical fiber 21 without being reflected. On the other hand, a light component 26 that travels toward the other end of the light collecting optical fiber 10, inputs into the photomultiplier 22 after being reflected by the reflector 28. Based on the same principle as stated above, in this case the location of light incident in the light collecting optical fiber 10 can also be detected from the time difference Δt between the time t₁ when the light component 25 without being reflected at the end of the light collecting portion 10 inputs to the photomultiplier 22 and the time t₂ when the light component 26 reflected at the end of the optical fiber inputs to the photomultiplier 22.

In the configuration of FIG. 9, one end of the light collecting optical fiber 10 is connected to the photomultiplier 22a via the optical fiber 21a and the other end of the light collecting optical fiber 10 is connected to the photomultiplier 22b via the optical fiber 21b. The signal processor 23 detects the incident location of light in the light collecting optical fiber 10 from the outputs of the photomultipliers 22a and 22b. More specifically, the signal processor 23 detects the time t₁ when a light component 25a, which travels toward one end of the light collecting optical fiber 10, inputs into the photomultiplier 22a and the time t₂ when a light component 26 which travels toward the other end of the light collecting optical fiber 10, inputs into the photomultiplier 22b. The time difference Δt=t₂−t₁ depends on the location of light incident to the light collecting optical fiber 10. For example, when the time difference is zero, it indicates that the light was incident to the location where the optical lengths from the photomultipliers 22a and 22b are equal. On the other hand, when the time difference is positive, it indicates that the incident location was closer to the photomultiplier 22a than the point of equal optical length from the photomultipliers 22a and 22b. Conversely, if the time difference is negative, it means the incident location was closer to the photomultiplier 22b. Thus, from the time difference the location of light incident can be detected. The signal processor 23 calculates the time difference Δt from the times t₁ and t₂, and detects the incident location of light in the light collecting optical fiber 10.

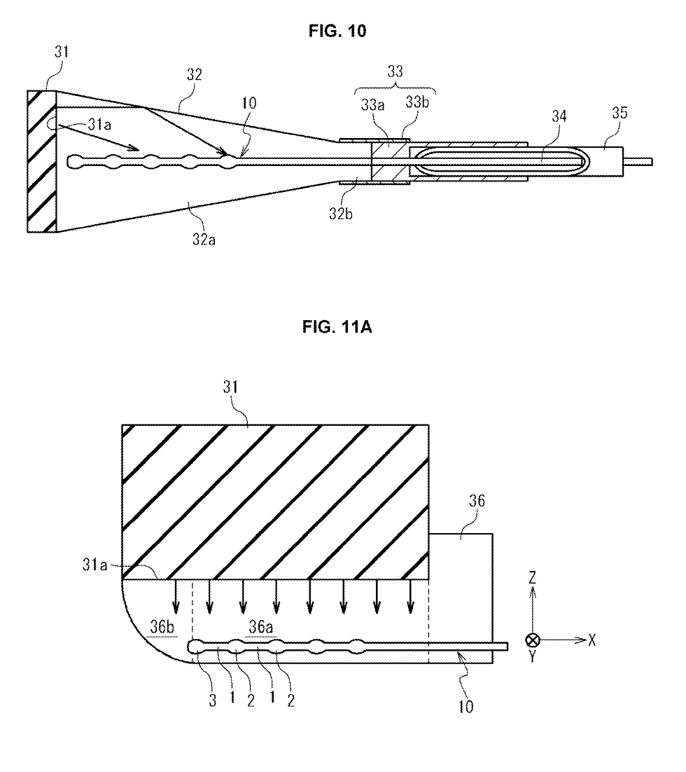

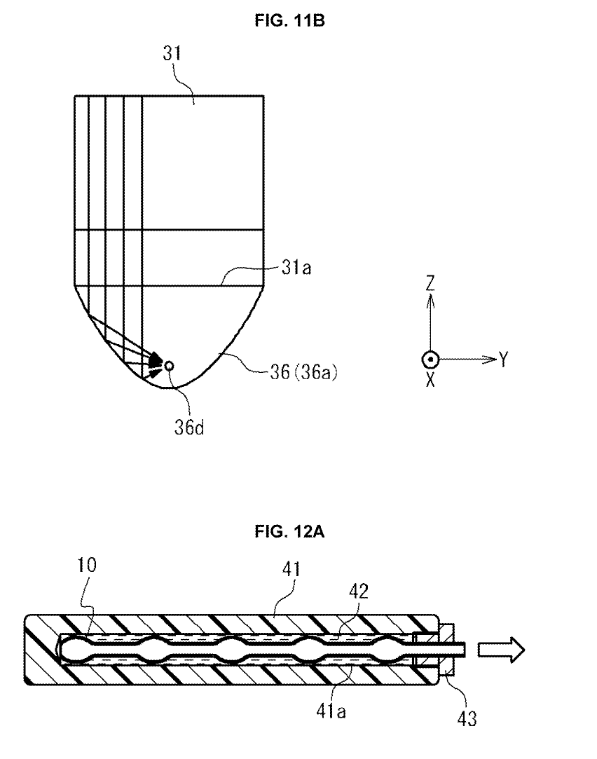

Further improvement in light injection efficiency can be achieved by embedding the light collecting optical fiber 10 of the present embodiment to the light guide, as shown in FIGS. 10, 11A and 11B. FIG. 10 is a cross sectional view showing the optical coupling structure to inject light to the light collecting optical fiber 10 from the light source located on the extended line of the center axis of the light collecting optical fiber 10. The light guide 32 is attached to the light emitting surface 31a of the light source 31. As for the light source 31, a scintillator which emits lights by the input of radioactive ray may be used. The light guide 32 can be formed with a transparent resin such as acrylic, for example.

The light guide 32 comprises a body part 32a having the shape of a circular truncated cone and an insertion part having the shape of a column and formed at the smaller end of the body part 32a. The outer diameter of the body part 32a decreases as the distance from the light emitting surface increases. The light collecting optical fiber 10 is embedded in the light guide 32 having the shape stated above. The light collecting optical fiber 10 is aligned so that its center axis fits in the center axis of the body part 32a of the light guide 32, and the base end of the light collecting optical fiber 10 fits in the end surface of the insertion part 32b. The insertion part 32b of the light guide 32 is inserted into the connecting sleeve 33. The connecting sleeve 33 comprises a sleeve body part 33a and a receptacle tube 33b. The receptacle tube 33b is bonded to the outer surface of the body part 33a and receives the insertion part 32b of the light guide 32. A through hole is opened through the sleeve body part 33a, through which the optical fiber 34 is inserted. The end of the optical fiber 34 is protected by the connecting sleeve 33 and is forced to contact with the base end of the light collecting optical fiber 10, which enables the optical connection between the light collecting optical fiber 10 and the optical fiber 34. The optical fiber 34 is inserted into the light shield tube 35, and the light shield tube 35 is inserted into the hole of the sleeve body part 33a of the connecting sleeve 33.

With the light coupling structure shown in FIG. 10, the light emitted from the light source 31 enters into the light collecting optical fiber 10 directly or after being reflected by the surface of the light guide 32, whereby realizes efficient collection of the light emitted from the light source 31 by the light collecting optical fiber 10. The light that was incident to the light collecting optical fiber 10 enters into the end of the optical fiber 34 and is further guided to the intended equipment.

FIGS. 11A and 11B shows a cross sectional view of the optical coupling structure to inject light into the light collecting optical fiber 10 from the light source 31 aligned laterally to the light collecting optical fiber 10. In explanation below, the XYZ Cartesian coordinate system defined as following is used: X axis is taken along the center axis of the light collecting optical fiber 10, Y axis and Z axis are taken in directions vertical to the center axis of the light collecting optical fiber 10, where Y axis is taken along the emitting surface 31a, Z axis is taken perpendicular to the Y axis. FIG. 11A shows a cross sectional view in the XZ cross section, while FIG. 11B shows one in YZ cross section.

As shown in FIG. 11A, the light source 31 is attached to the light guide 36. As for the light source 31, a scintillator which emits light by the irradiation of radioactive rays may be used. The light guide 36 is formed with a transparent resin such as acrylic. The light guide 36 comprises the body part 36a and the end part 36b. The light emitting surface 31a of the light source 31 is attached to the body part 36a and the end part 36b of the light guide 36.

The body part 36a of the light guide 36 is formed so that its surface plots a parabola in YZ cross section, having the axis of the parabola perpendicular to the light emitting surface 31a. The light collecting optical fiber 10 is embedded in the body part 36a of the light guide 36, so that the center axis of the light collecting optical fiber 10 is at the focal point 36d of the parabola. An advantage of this type of structure is that any light emitted vertically from the light emitting surface 31a and then enters into the body part 36a gathers on the light collecting optical fiber 10, irrespective of the emitting point. This feature contributes to improve the light injection efficiency of the light collecting optical fiber 10.

The end part 36b has a shape wherein the surface curves to form a parabola in the YZ cross section, where the axis of the parabola is perpendicular to the light emitting surface 31a. Further, the end part 36b preferably has a shape wherein the surface curves to form a parabola in the XZ cross section also, where the axis of the parabola is perpendicular to the light emitting surface 31a. Here, the light collecting portion 3 at the end of the light collecting optical fiber 10 preferably is at the focal point of the parabola plotted by the surface in the XZ cross section. The light collection efficiency of the light collecting optical fiber 10 can be effectively improved by this structure.

2. Detection of Radioactive Rays Using the Light Collecting Optical Fiber

Detecting radioactive rays is one of the preferable applications of the embodiments of the light collecting optical fiber 10 of the present invention. By aligning the light collecting optical fiber 10 close to (typically by embedding in) the scintillator which emits light corresponding to the incident radioactive ray (for example, X ray, β ray, gamma ray,) a radioactive ray detector system that detect radioactive ray can be constituted. The type of scintillator may be selected depending on the type of radioactive ray to be detected. By adopting the structure of the light collecting optical fiber 10 as described above, the injection efficiency of the light generated in the scintillator can be improved, thereby the sensitivity in detecting the radioactive ray can also be improved.

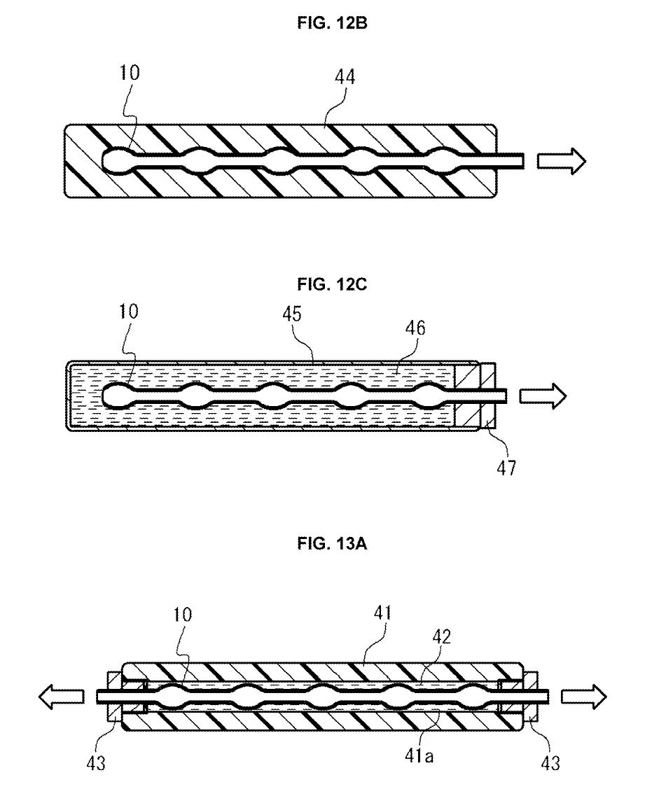

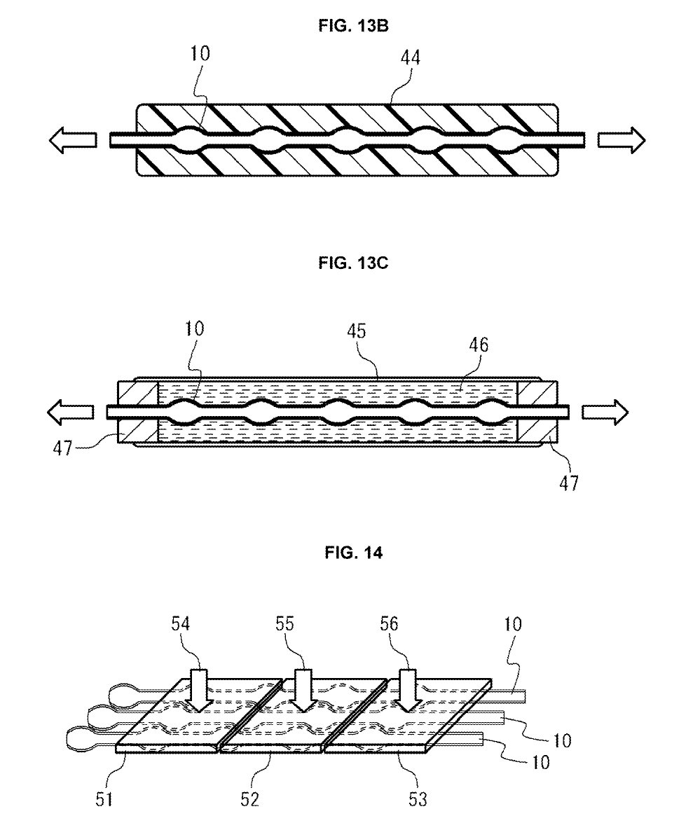

FIGS. 12 A to 12C and FIGS. 13 A to 13C show cross sectional views of the structures of the radioactive ray detecting units wherein the light collecting optical fibers are embedded in the scintillators.

Referring FIG. 12A, in one of the embodiments, a hole 41a is formed in the scintillator 41 and the light collecting optical fiber 10 is inserted into the hole 41a. The portion of the light collecting fiber 10 including at least the light collecting portions 2 and 3 is installed in the hole 41a. In FIG. 12A, the light collecting optical fiber 10 that has been configured to take out light from the one end. As for the scintillator 41, a plastic scintillator or inorganic crystal scintillators (for example, NaI, BGO, GSO, LSO, LaBr3) may be used.

An optical gel 42 is filled in the space between the light collecting optical fiber 10 and the inner face of the hole 41a. The optical gel 42 has a refractive index between the refractive index of the light collecting optical fiber and that of the scintillator. The optical gel 42 is used to improve the optical coupling between the light collecting optical fiber 10 and the scintillator 41, and thereby to improve the injection efficiency to the light collecting optical fiber 10. In order to prevent the optical gel from leaking, the entrance of the hole 41a is sealed by the seal 43, through which a through hole to insert the light collecting optical fiber 10 is formed. The base end of the light collecting optical fiber 10 is connected to the photodetector directly or via an optical fiber.

In the radioactive ray detecting unit with such a configuration, the scintillator 41 emits lights when the radio active ray to be detected enters into the scintillator 41. The generated lights are collected by the light collecting optical fiber 10. The collected lights are sent to the photodetector, where the incident event of the radioactive ray can be detected by detecting the light. The photodetection system, which detects the lights collected by the light collecting optical fiber 10 may be configured as shown in FIG. 6, for example.

When a plastic scintillator is used as the scintillator, the light collecting optical fiber 10 may be embedded in the plastic scintillator 44 so that a whole part of the surface of the light collecting optical fiber 10 that is within the plastic scintillator 44 adheres tightly to the plastic scintillator 44, as shown in FIG. 12 B. In such a configuration, a good optical coupling between the plastic scintillator 44 and the light collecting optical fiber 10 can be achieved. The structure shown in FIG. 12 B can be easily achieved by embedding the light collecting optical fiber 10 when forming the plastic scintillator 44.

On the other hand, the structure shown in FIG. 12A is preferable to the one shown in FIG. 12B, when an inorganic material is used as the scintillator. In case of an inorganic scintillator, the structure shown in FIG. 12B would be hard to be achieved, since the inorganic scintillator is hard to treat by plastic forming. The structure shown in FIG. 12A, which requires just forming a hole in the inorganic crystal scintillator, can be easily achieved.

A liquid scintillator may be used as a scintillator. FIG. 12C shows a cross sectional view for a radioactive ray detector unit, which utilizes a liquid scintillator. The light collecting optical fiber 10 is inserted into the enclosure container 45 and the liquid scintillator is encapsulated in it. The inlet port of the enclosure container 45 is sealed by the plug 47. This structure can realize a detection of the radioactive ray detector.

In the radioactive ray detectors of FIGS. 12A to 12C, the light collecting optical fiber 10 being configured to reflect light at the end may be used. In such a case, the radioactive ray detector which detects the incident location of the radioactive ray may be configured by using the configuration of the optical detection system as shown in FIG. 7.

As shown in FIGS. 13A to 13C, the light collecting optical fiber 10 configured to take out lights from both ends may also be adopted. In such situations, the configuration of the light detection system of FIG. 8 or 9 may be adopted in order to detect the incident location of the radioactive ray.

FIG. 14 shows a bird's eye view of the radioactive ray detector unit utilizing the light collecting optical fiber 10. In the radioactive ray detector unit possessing the configuration shown in FIG. 14, three light collecting optical fibers 10 are arrayed in parallel and further they are embedded in three plate-like scintillators 51, 52 and 53 that are arrayed in the length direction of the light collecting optical fibers. The scintillators 51, 52 and 53 each have sensitivities to different types of radioactive rays, and further each emits light in a different wavelength. For example, the scintillator 51 has a sensitivity to gamma rays, the scintillator 52 has a sensitivity to beta rays, the scintillator 53 has a sensitivity to neutrons. When radioactive rays of a first type 54 (for example, gamma rays) are incident into the scintillator 51, the scintillator 51 generates lights of a first wavelength which are collected by the light collecting optical fiber 10. When radioactive rays of a second type 55 (for example beta rays) are incident into the scintillator 52, the scintillator 52 generates lights in a second wavelength, which are collected by the light collecting optical fiber 10. When radioactive rays of a third type 56 (for example, neutron rays) are incident into the scintillator 53, the scintillator 53 generates lights in a third wavelength, which are collected by the collecting optical fiber 10. The light collecting optical fiber 10 collects lights generated and output them. The radioactive ray detection unit of the above configuration is enabled to detect an incidence of a radioactive ray and a type of radioactive ray by connecting the light collecting optical fiber to a photodetector that can distinguish the wavelength of the incident light.

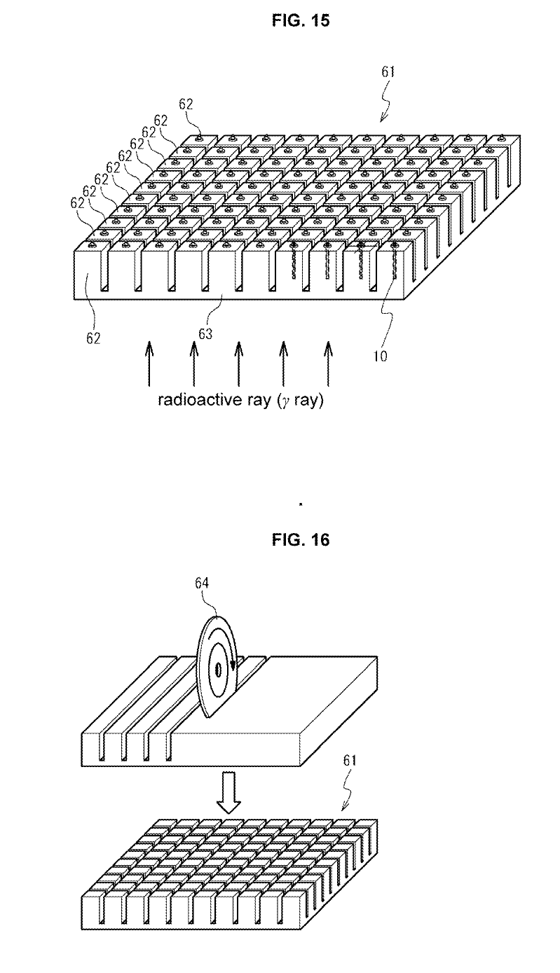

An image of light caused by the radioactive rays can be taken by an arrayed configuration of the scintillators and the light collecting optical fibers 10. FIG. 15 shows a bird's eye view of the radioactive ray detector, where the scintillators and the light collecting optical fibers 10 are configured as two dimensional arrays. Upon the scintillator body structure 61, slits are formed in a matrix pattern, which forms the scintillator blocks 62. The scintillator blocks 62 are used to actually detect the radioactive rays. The scintillator blocks are not separated completely but one side of the scintillator blocks are connected via the base part 63. This structure enables a high density configuration of the scintillator blocks 62 to detect the radioactive rays. The scintillator body structure 61 shown in FIG. 15 may be formed by cutting a plate-like scintillator by rotary teeth of a blade 64 down to the middle point of thickness direction.

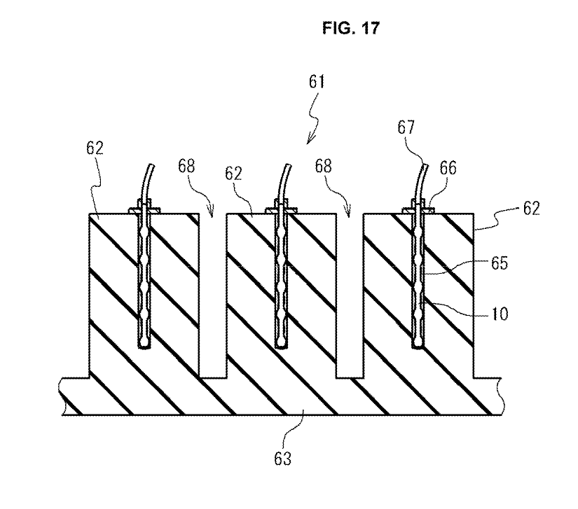

FIG. 17 is a cross section showing a detail of the radioactive ray detector block 62. In FIG. 17, the arrow 68 indicates a slit to separate the scintillator block 62. Each of the scintillator blocks 62 has a hole, to which the light collecting optical fiber is inserted. FIG. 15 indicates that the light collecting optical fibers are inserted only in a part of the scintillator blocks for simplicity. However, note that the light collecting optical fibers are inserted in every scintillator blocks. In FIG. 17, the optical gel 65 is filled in the space between the light collecting optical fiber 10 and the inner surface of the hole. The optical gel 65 has a refractive index between the refractive index of the light collecting optical fiber and that of the scintillator, thereby, the optical gel improves the optical coupling between the light collecting optical fiber 10 and the scintillator block 62. The hole into which the light collecting optical fiber is inserted, is sealed with the plug 66, which prevents the optical gel 65 from leaking. The plug 66 also functions as a connecting sleeve, which supports the light collecting optical fiber 10 and the optical fiber 67. An end of the optical fiber 67 is pressed against the end of the light collecting optical fiber 10, by which the optical fiber 67 is optically connected with the light collecting fiber 10. The other end of the optical fiber 67 is connected to the photodetector. Thus, the light incident into each light collecting optical fiber is detected by the photodetector.

Using the configuration described above, the radioactive ray incident into each scintillator block 62 can be detected and the image caused by the radioactive rays can be taken. The radioactive ray detector unit of the configuration shown in FIG. 15 may be applied to a PET (Positron Emission Tomography) system, for example.

Although various embodiments of the light collecting optical fiber under the present invention are discussed as above, the present invention can be embodied in various other ways. Therefore, the present invention should not be interpreted as limiting to the above embodiments. Particularly, it should be noted that the light collecting optical fiber of the present invention can be applied to various applications other than the radioactive ray detector system. For example, the light collecting optical fiber of the present invention may be used as a light collecting part of a sunlight introduction system which injects sunlight from the light collecting part aligned on the roof into a lighting panel in a house via bundle of optical fibers.

What is claimed is:

1. A light collecting optical fiber comprising:
a plurality of optical waveguide portions constituting an optical fiber extending in a length direction
wherein each of the plurality of optical waveguide portions comprises a core and a clad that surrounds the core; and
a light collecting portion inserted between two of the optical waveguide portions that are adjacent each other,
wherein the light collecting portion is formed in a shape bulging out from the waveguide portion in a radial direction that is perpendicular to the length direction, and is constituted so that the light collecting portion injects external light into the optical waveguide portion.

2. The light collecting optical fiber of claim 1, wherein
the shapes of the optical waveguide portion and the light collecting portion in a cross section perpendicular to the length direction are circular,
the light collecting portion comprises a core and a clad that is surrounding the core, and
the core of the light collecting portion has a diameter larger than that of the core of the optical waveguide portion.

3. The light collecting optical fiber of claim 2, wherein
the core of the light collecting portion is constituted so that the diameter of the core of the light collecting portion increases toward a specified cross section which crosses the light collecting portion and which is perpendicular to the length direction, and
has a maximum diameter of the core of the light collecting portion at the specified cross section, wherein further the change rate of the diameter of the core of the light collecting portion is zero at the specified cross section.

4. The light collecting optical fiber of claim 1, further comprising:
an end light collecting portion, that is attached to an end of the optical waveguide portion located at the most end side of the light collecting optical fiber among the plurality of optical waveguide portions, wherein
the end light collecting portion is formed in a shape bulging out from the most end optical waveguide portion in a radial direction that is perpendicular to the length direction, and is constituted so that the end light collecting portion injects external light into the most end optical waveguide portion.

5. The light collecting optical fiber of claim 1, wherein
a reflection coating that reflects light has been formed end of an end the most end optical waveguide portion located at the most end side of the light collecting optical fiber among the plurality of optical waveguide portions.

6. The light collecting optical fiber of claim 1, wherein
a low refractive index layer that has a refractive index, lower than the refractive index of the core but higher than that of air, has been formed at the end of the most end optical waveguide portion located at the most end side of the light collecting optical fiber among the plurality of optical waveguide portions.

7. The light collecting optical fiber of claim 1, wherein
the optical waveguide portions are located at both ends of the light collecting optical fiber so that the light collected can be taken out from the both ends of the light collecting optical fiber.

8. A photodetection system, comprising:
the light collecting optical fiber of claim 1; and
a photodetector connected at least one end of the light collecting optical fiber.

9. A photodetection system, comprising:
the light collecting optical fiber of claim 5;
a photodetector connected to a base end of the light collecting optical fiber; and
a signal processing unit which receives the output signal of the photodetector, wherein
the signal processing unit calculates from the output signal
a first time when a first light component of the external light collected by the light collecting optical fiber, without being reflected at the end of the light collecting optical fiber, arrived at the photodetector, and
a second time when a second light component which was reflected at the end of the light collecting optical fiber arrived at the photodetector, and
detects the location where an external light incident into the light collecting optical fiber.

10. A photodetection system, comprising:
the light collecting optical fiber of claim 7;
a photodetector connected to one end of the light collecting optical fiber;
a light reflecting means connected to the other end of the light collecting optical fiber; and
a signal processing unit which receives the output signal of the photodetector, wherein
the signal processing unit
calculates from the output signal
a first time when a first light component of the external light collected by the light collecting optical fiber, without being reflected by the light reflecting means, arrived at the photodetector, and
a second time when a second light component which was reflected at the light reflecting means arrived at the photodetector, and
detects the location where the external light incident into the light collecting optical fiber.

11. A photodetection system, comprising:
the light collecting optical fiber of claim 7;
a first photodetector connected to a first end of the light collecting optical fiber;
a second photodetector connected to a second end of the light collecting optical fiber; and
a signal processing unit which receives the output signals of the first and the second photodetectors, wherein
the signal processing unit calculates from the output signal,
a first time when a first light component, which travels from the first end to the first photodetector, arrived at the first photodetector, and a second time when a second light component, which travels from the second end to the second photodetector, arrived at the second photodetector, and
detects the location where the external light incident into the light collecting optical fiber.

12. An optical coupling structure comprising:
the light collecting optical fiber according to claim 1; and
a light guide to be attached to a light source, wherein
the light collecting optical fiber is embedded in the light guide, whereby lights emitted from the light source are injected into the light collecting optical fiber.

13. The optical coupling structure of claim 12, wherein
the light source is located on an extended line of the center line of the light collecting optical fiber, and
the light guide is attached to the light source and is constituted to include a portion which is so configured so that the further from the light source the portion is, the smaller the diameter of the portion.

14. The optical coupling structure of claim 12, wherein
the light emitting surface of the light source is configured to be in parallel to the center axis of the light collecting optical fiber,
the light guide is attached to the light emitting surface and has a body part with such a shape as the outer surface of the body part plots a parabola in a cross section perpendicular to the center axis of the light collecting optical fiber, wherein the axis of the parabola is perpendicular to the light emitting surface, and
the center axis of the light collecting optical fiber is positioned at the focal point of the parabola.

15. An optical coupling structure comprising:
the light collecting optical fiber of claim 4; and
a light guide attached to a light source, wherein
the light emitting surface of the light source is configured to be in parallel to the center axis of the light collecting optical fiber, and
the light guide further comprising:
a body part being attached to the light emitting surface; and
an end part being formed at an end of the body part and attached to the light emitting surface, wherein further
the body part has such a shape as an outer surface of the body part plots a first parabola in a cross section perpendicular to the center axis of the light collecting optical fiber,
the axis of the first parabola is perpendicular to the light emitting surface,
the center axis of the light collecting optical fiber is positioned at the focal point of the first parabola,
wherein the end part has such a shape as the outer surface of the end part plots a second parabola in a cross section that is perpendicular to the light emitting surface and that is including the center axis, and
the end light collecting portion of the light collecting optical fiber is located at the focal point of the second parabola.

16. A radioactive ray detecting unit comprising:
the light collecting optical fiber according to claim 1; and
a scintillator being placed adjacent to the light collecting optical fiber.

17. The radioactive ray detecting unit of claim 16, wherein
at least a portion including the light collecting portion of the light collecting optical fiber being inserted in a hole opened in the scintillator.

18. The radioactive ray detecting unit of claim 17, wherein
an optical gel having a refractive index between the refractive index of the scintillator and that of the core, is filled in a space between the inner surface of the hole and the light collecting optical fiber.

19. The radioactive ray detecting unit of claim 16, wherein
the scintillator is a plastic scintillator, and
a part of the light collecting optical fiber that is inside of the scintillator is embedded in the scintillator so that a whole surface that is inside of the scintillator adheres tightly to the scintillator.

20. The radioactive ray detecting unit of claim 16, further comprising:
an enclosure container, wherein
the scintillator is a liquid scintillator, and
the enclosure container contains the liquid scintillator and a part of the light collecting optical fiber including at least the light collecting portion.

21. A radioactive ray detecting unit comprising:
the light collecting optical fibers according to claim 1; and
a plurality of scintillators being placed adjacent to the light collecting optical fiber, wherein
the plurality of scintillators are configured each to have a different sensitivity to a radioactive ray, and
the plurality of scintillators emit lights in different wavelengths.

22. A radioactive ray detecting unit comprising:
a plurality of the light collecting optical fibers according to claim 1;
a plurality of scintillator blocks being separated by slits; and
a scintillator structure body including a base connecting the plurality of scintillator blocks, wherein
each of the plurality of the light collecting optical fibers is inserted into each of the holes of the plurality of the scintillator blocks.

23. The radioactive ray detecting unit of claim 17, wherein
an optical gel having a refractive index between the refractive index of the scintillator block and that of the core, is filled in a space between the inner surface of the hole and the light collecting optical fiber.
